(19) United States
(12) Patent Application Publication
(10) Pub. No.: US 2025/0178569 A1
(43) Pub. Date: Jun. 5, 2025

(54) WIPER SYSTEM FOR A LIDAR SENSOR

(71) Applicant: Robert Bosch GmbH, Stuttgart (DE)

(72) Inventors: Gyorgy Szabo, Budapest (HU); Istvan Gugyella, Budapest (HU); Mate Hornyak, Pakozd (HU); Peter Deak, Budapest (HU); Zoltan Gyonyoru, Budapest (HU)

(21) Appl. No.: 18/946,568

(22) Filed: Nov. 13, 2024

(30) Foreign Application Priority Data
Nov. 30, 2023 (DE) 10 2023 212 006.2

(51) Int. Cl. B60S 1/56; B60S 1/38; G01S 7/481; G01S 17/931

(52) U.S. Cl. CPC B60S 1/56; B60S 1/3856; G01S 7/4813; G01S 17/931

(57) ABSTRACT

A wiper system for a LiDAR sensor includes a wiper lip having an elastic material. The wiper lip has a longitudinal extension direction. The wiper system includes two bars, the two bars configured to engage in two recesses and the wiper lip along the longitudinal extension direction. The wiper system further includes a limiting unit, which is configured to be pushed along the longitudinal extension direction onto the wiper lip to secure the two bars to the wiper lip. The wiper system also includes a connecting unit, which is configured to form a friction-locking and/or positive-locking connection with the two bars. The connecting unit is configured to arrange the wiper system on a cleaning system for the LiDAR sensor.

### BACKGROUND

The present invention relates to a wiper system for a LiDAR sensor, a cleaning system for a LiDAR sensor, and a vehicle.

There are currently a plurality of different solutions for cleaning sensor surfaces in vehicles. Due to the increasing number of sensor surfaces to be cleaned in the vehicle sector and increased cleaning quality requirements, the demand for innovative and robust methods for cleaning sensor surfaces is continuously increasing.

Continuous weight reduction in the vehicle sector to reduce consumption and increasing competition are putting pressure on costs, resulting in greater demand for inexpensive and more efficient vehicle components.

### SUMMARY

The wiper system according to the invention for a LiDAR sensor with the features of the disclosure has an advantage over known systems in that a wiper lip of the LiDAR sensor can be replaced with little force by the limiting unit and the connecting unit without tools or the like. A further advantage is that the load on the wiper system can be reduced further, because the wiper lip can be further deflected in the presence of an obstacle with the aid of the bars of the wiper system in order to possibly overcome this obstacle. Thus, a material which has a long service life and which at the same time can be deflected to its connection can be used for the wiper lip can, so that the overall elasticity of the wiper lip can be reduced.

This is achieved according to the invention in that the wiper system for a LiDAR sensor comprises a wiper lip, which comprises an elastic material. Further, the wiper lip has a longitudinal extension direction. In addition, the wiper system comprises two bars, wherein the two bars are designed engage with two recesses on the wiper lip along the longitudinal extension direction, wherein the wiper system comprises a limiting unit, which is designed to be pushed onto the wiper lip along the longitudinal extension direction to secure the two bars to the wiper lip, wherein the wiper system comprises a connecting unit which is designed to form a frictional and/or positive-locking connection to the two bars, wherein the connecting unit is configured to arrange the wiper system on a cleaning system for the LiDAR sensor.

In other words, a wiper lip has two lateral recesses into which two bars can be inserted. The bars are thereby held in the recesses, on the one hand with a limiting unit, which are inserted over the ends along the longitudinal extension direction, as well as by the connecting unit, which can attach the wiper system to the cleaning system of the LiDAR sensor. Preferably, the wiper lip is made from a rubber-like material. Further preferably, the two bars, the limiting unit and the connecting unit can be made from a plastic, for example PA6. Thus, the bars may have a higher strength than the wiper lip.

Preferably, the two bars have two tapers, wherein the connecting unit is adapted to prevent slippage of the connecting unit against the wiper lip along the longitudinal extension direction because the connecting unit engages with the tapers.

An advantage of this embodiment is that the wiper lip remains in the field of view of the sensor in order to be able to further improve cleaning performance. In particular, each bar can have a taper, which is arranged on the bars in particular opposite to the longitudinal extension direction. Further preferably, the connecting unit may comprise pin elements or the like that are adapted to engage in the taper. Further, the connecting unit forms a frictional and/or positive-locking connection with the bar in the taper to thus prevent slipping along the longitudinal extension direction.

Further, preferably, the connecting unit comprises a U-shaped portion, wherein the U-shaped portion and the two bars are designed to provide the frictional and/or positive-locking connection.

An advantage of this embodiment is that the U-shaped portion can secure the connecting unit to the bars along two axes. Thus, slipping between the bars and the connecting unit can be prevented.

Further preferably, the connecting unit comprises a phase abutting the U-shaped portion to assist in forming the frictional and/or positive-locking connection.

An advantage of this embodiment is that the mounting of the connecting unit to the bars can be further simplified.

Preferably, a length of the two tapers and a length of the U-shaped portion are adapted to define a degree of deflection of the wiper lip to the connecting unit when the wiper lip is moved over the LiDAR sensor.

An advantage of this embodiment is that when the wiper lip encounters an obstruction adhering to the field of view of the LiDAR sensor, the movement will not be interrupted due to the defined deflection between the wiper lip and the connection unit, but rather it can deflect the wiper lip accordingly to overcome the obstruction. In so doing, a degree of deflection can be defined based on the length of the two tapers or a length of the U-shaped portion, because the longer the two lengths, the lower the deflection can be.

Further preferably, the two bars each comprise a first hook element, wherein the limiting unit comprises two second hook elements, wherein the two bars form a snap hook connection between the two bars and the limiting unit by means of the first hook elements and the second hook elements.

An advantage of this embodiment is that a snap hook connection can be completed by attaching the limiting unit to the two bars and the wiper lip. The limiting unit is thus mounted on the bars and the wiper lip so that it can be released and replaced if necessary.

Further preferably, the limiting unit has a U-shaped profile, wherein the U-shaped profile is designed to guide at least one bar to form the snap hook connection.

An advantage of this embodiment is that hooking of the first and the second hook elements to each other or to another component through the U-shaped profile is reduced or avoided. The limiting unit can have a U-shaped profile on both sides in order to be able to guide the bar.

Preferably, the limiting unit comprises two pins adapted to engage in the two recesses to form a frictional connection between the wiper lip and the limiting unit.

An advantage of this embodiment is that, when the limiting unit is fitted to the wiper lip with the bars, a frictional connection is formed between the limiting unit and the wiper lip by means of the pins in order to be able to prevent the limiting unit from slipping down from the wiper lip or the bars.

Further preferably, the connecting unit comprises two cut-outs, wherein a clip is arranged in each of the two cut-outs, wherein the clip is designed to form a frictional—and/or a positive-locking connection with the cleaning system.

An advantage of this embodiment is that the wiper system can be positioned on the cleaning system of the LiDAR sensor by simply inserting it. A further advantage is that, by using the cut-outs in which the clips are arranged, the wiper system does not contribute or impart to the overall height of the cleaning system.

Further preferably, the clip has an opening width that is larger than a diameter of a fastening location of the clip.

An advantage of this embodiment is that the opening width creates a certain guiding effect, so that the wiper system can be more easily attached to the cleaning system.

Preferably, the clip has an opening angle of between 20° and 30°.

An advantage of this embodiment is that the opening angle may be used to improve a guiding effect in order to be able to attach the wiper system to the cleaning system more easily.

Preferably, the clip has two arms, wherein a tip or peak width of the arms is less than a base width of the arms.

Another advantage of this embodiment is that the guiding effect of the clip is further improved with the help of the adapted tip or peak width and base width, to simplify mounting of the wiper system to the cleaning system.

Preferably, the tip or peak width and the base width of the clip are adapted to form a resistance force for mounting the wiper system between 3 and 20 N.

An advantage of this embodiment is that from the point when this force is overcome, a click-in noise or similar can occur when the wiper system is clicked onto the cleaning arm of the cleaning system so that the installer can check whether the wiper system has been successfully mounted.

Another aspect of the invention relates to a cleaning system for a LiDAR sensor comprising a wiper system as described above and below, wherein the cleaning system is adapted to move the wiper system over a field of view of the LiDAR sensor to clean the field of view.

Another aspect of the invention relates to a vehicle comprising a cleaning system as described above and below and/or a wiper system as described above and below.

### BRIEF DESCRIPTION OF THE DRAWINGS

In the following, exemplary embodiments of the invention are described in detail with reference to the accompanying drawings. The drawings show:

FIGS. 1 to 9 a wiper system according to one embodiment,

FIG. 10 a cleaning system according to one embodiment,

FIG. 11 a vehicle according to one embodiment.

### DETAILED DESCRIPTION

Preferably, all the same units, elements, and/or systems are provided with the same reference signs in all the figures.

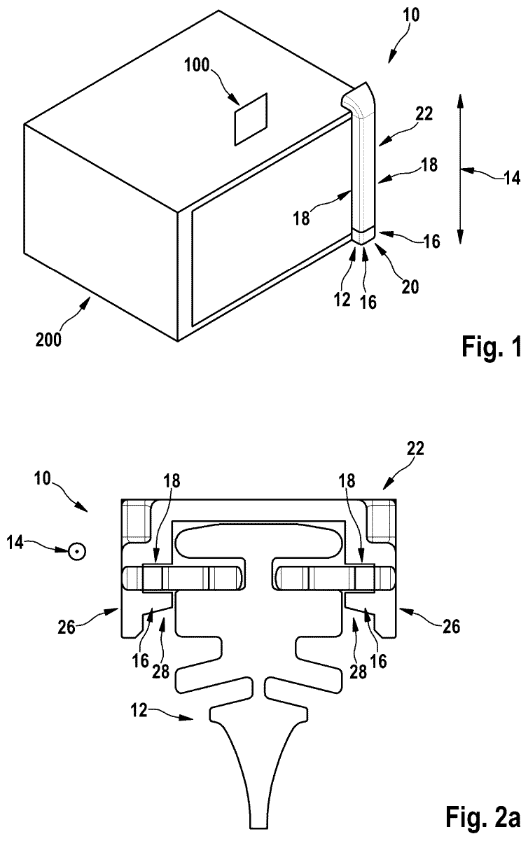

FIG. 1 shows a wiper system 10 according to one embodiment. Preferably, the wiper system 10 for a LiDAR sensor 200 comprises a wiper lip 12 made of an elastic material. Further, preferably, the wiper lip 12 has a longitudinal extension direction 14. Preferably, the wiper system comprises two bars 16, wherein the two bars 16 are adapted to engage in two recesses 18 on the wiper lip 12 along the longitudinal extension direction 14, wherein the wiper system 10 comprises a limiting unit 20, which is designed to be pushed onto the wiper lip 12 along the longitudinal extension direction 14 to secure the two bars 16 to the wiper lip 12, wherein the wiper system 10 comprises a connecting unit 22, which is designed to form a frictional and/or positive-locking connection to the two bars 16, wherein the connecting unit 22 is configured to arrange the wiper system 10 on a cleaning system 100 for the LiDAR sensor 200.

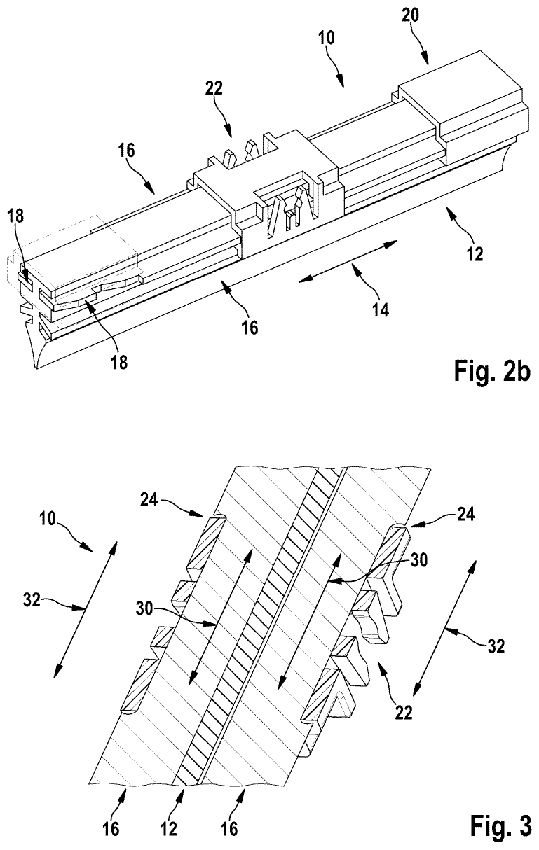

FIG. 2a shows a wiper system 10 according to one embodiment. FIG. 2a shows a sectional view of the wiper system 10 at a height of the connecting unit 22. Preferably, the wiper lip 12 is fixed in the connecting unit 22 by means of two bars 16 which engage in two recesses 18 of the wiper lip 12. Preferably, the connecting unit 22 comprises a U-shaped section 26, in particular on both sides of the wiper lip 12, into which the bars 16 engage. Thus, the bars 16 may form their frictional and/or positive-locking connection to the connecting unit 22 and a force and/or positive-locking connection of the wiper lip 12.

FIG. 2b shows a wiper system 10 according to one embodiment. The wiper system 10 has a similar configuration as the wiper system 10 of FIG. 2a. As can be seen in FIG. 2b, the two bars 16 of the wiper system 10 abut the wiper lip 12 in two recesses 18. The connecting unit 22 is arranged on the two bars 16. Further preferably, the limiting unit 20 can be pushed onto the wiper lip 12 and the bars along the longitudinal extension 16 in the direction of displacement 14.

FIG. 3 shows a wiper system 10 according to one embodiment. The wiper system 10 comprises a wiper lip 12 as well as two bars 16, which preferably comprise two tapers 24. The connecting unit 22 can engage with the tapers 24 to be able to form a frictional and/or positive-locking connection between the bars 16 and the connecting unit 22. Preferably, the two tapers 24 have a first length 30, and preferably the U-shaped portion 26 has a second length 32. The first length 30 and the second length 32 may be configured to define a degree of deflection of the wiper lip 12 to the connecting unit 22.

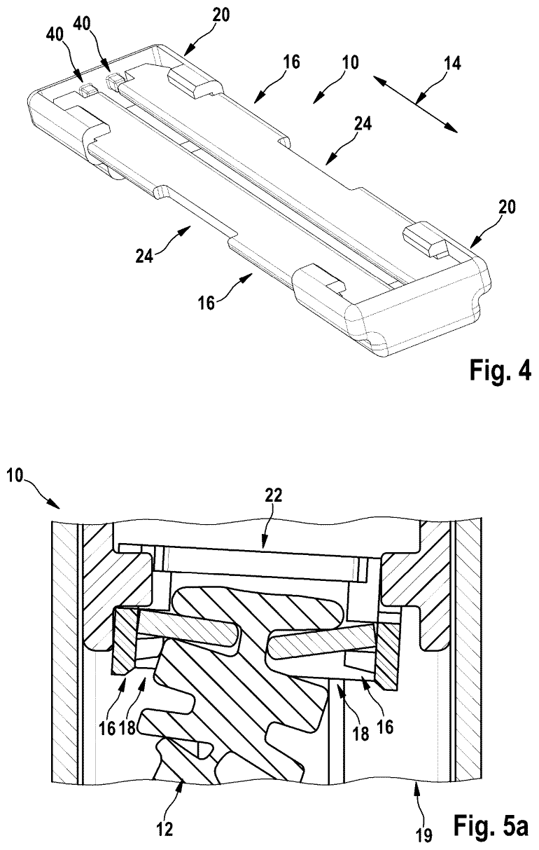

FIG. 4 shows one embodiment of the wiper system 10. The wiper system 10 comprises two bars 16 on which the limiting units 20 are attached. The limiting units 20, which are attached to the bars 16 on both sides, comprise two pins 40, which can form a frictional connection between the bars 16 and the limiting unit 20. Preferably, the limiting units 20 have been inserted on the bars 16 along the displacement direction 14. Further, preferably, the bars 16 comprise tapers 24 on which the connecting unit 22 can be arranged.

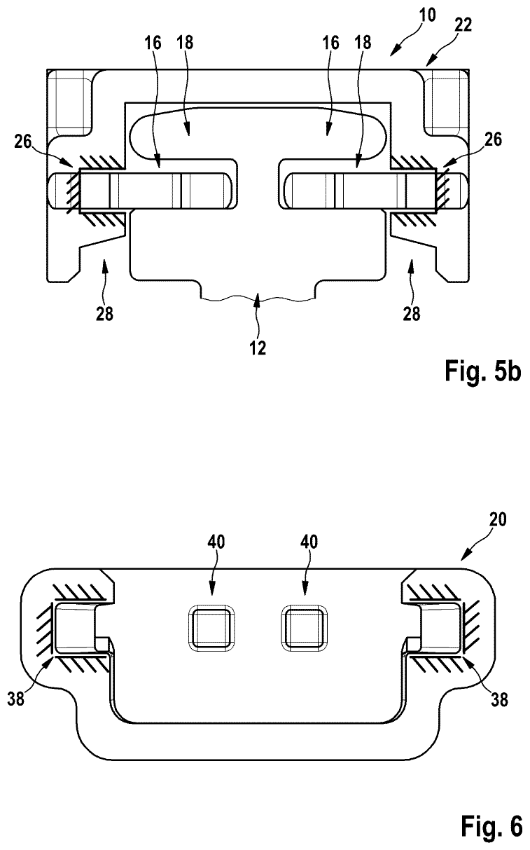

FIG. 5a shows a wiper system 10 according to one embodiment. The wiper system 10 comprises a wiper lip 12, which is arranged on a connecting unit 22 by means of bars 16 and recesses 18. As can be seen in FIG. 5a, a housing 19 of the connecting unit 22 can be arranged, for example, to protect the wiper lip 12 from environmental influences.

FIG. 5b shows a wiper system 10 according to one embodiment. As shown in FIG. 5a, the connecting unit 22 comprises a U-shaped section 26 for each bar 16. Adjacent the U-shaped portion, a phase 28 may be arranged to facilitate insertion of the bar 16 into the U-shaped sections 26.

FIG. 6 shows a wiper system 10 according to one embodiment. The wiper system 10 comprises a limiting unit 20. The limiting unit 20 comprises a U-shaped profile 38 on both sides, in particular for each bar 16. Further, preferably, the limiting unit comprises two pins 40 for forming a frictional connection with the recesses 18 of the wiper lip 12.

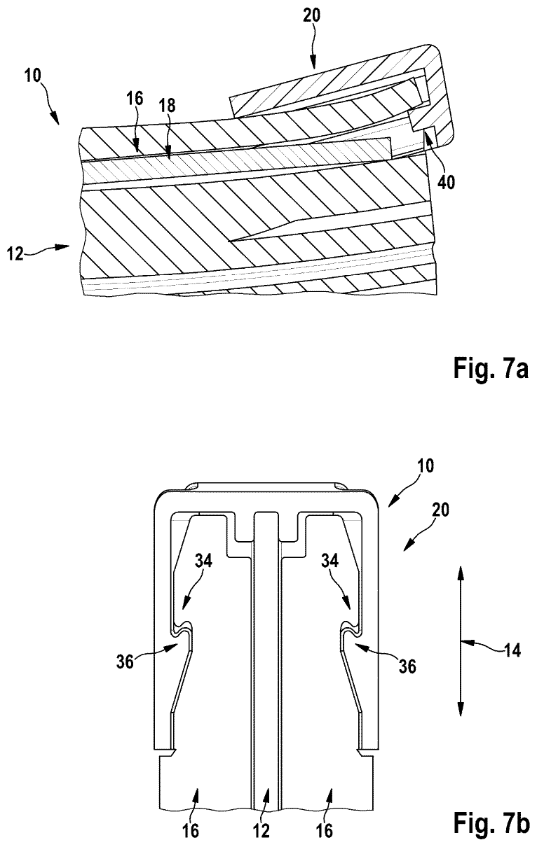

FIG. 7a shows one embodiment of the wiper system 10. The wiper system 10 comprises a wiper lip 12, which can be attached to the connecting unit 22 by means of two bars 16, which are arranged in the recess 18. Further preferably, a limiting unit 20 is pushed onto the wiper lip and/or the bars 16. Further, pins 40 in the limiting unit 20 may form a frictional connection to the wiper lip 12 by engaging the recesses 18, particularly along the displacement direction of the extension direction 14.

FIG. 7b shows one embodiment of the wiper system 10. The wiper system 10 has a similar configuration to the wiper system of FIG. 7a. Preferably, each bar 16 comprises a first hook element 34. The bars 16 can position the wiper lip 12 in relation to the limiting unit 20. The limiting unit 20 comprises a second hook element 36 for each bar 16 in order to be able to form a snap hook connection between the bars 16 and the limiting unit 20. In particular, the limiting unit 20 can be pushed along the longitudinal extension direction 14 onto the bars 16 and the wiper lip 12 in order to be able to form the snap hook connection.

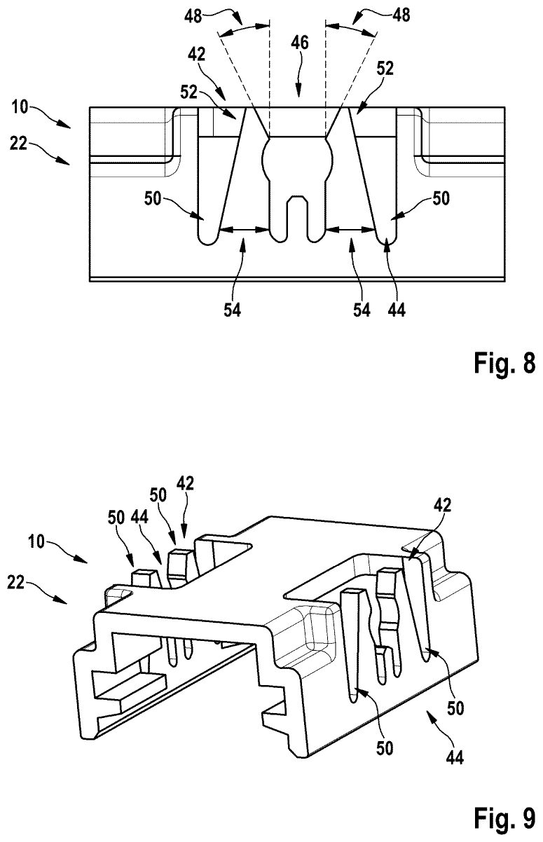

FIG. 8 shows one embodiment of the wiper system 10. The wiper system 10 comprises a connecting unit 22. Preferably, the connecting unit 22 comprises two cut-outs 42, with a clip 44 arranged in each. Each clip 44 has an opening angle 46, which is larger than a diameter of the fastening clip of the clip 44. Further preferably, each clip 44 has an opening angle 48 in particular between 20° and 30° to a longitudinal extension direction of the clip element, in particular an arm 50 of the clip 44. Further preferably, the clip 44 comprises two arms 50 having a peak width 52 of the arms and a base width 54 of the arms 50. Preferably, the peak width 52 is less than a base width 54 of the arms 50. Further preferably, the peak width 52 of the clip 44 and the base width 54 of the clip 44 are designed to create a resistance force for the mounting of the wiper system 10 between 3 and 20 N.

FIG. 9 shows a wiper system 10 according to one embodiment. The wiper system 10 comprises a connecting unit 22. As can be seen in FIG. 9, the connecting unit 22 comprises a cut-out 42 on both sides, on which a clip 44 is arranged. Each clip 44 comprises two arms 50. Specifically, the connecting unit 22 can be applied or attached to the cleaning system 100 using the deflection of the arms 50.

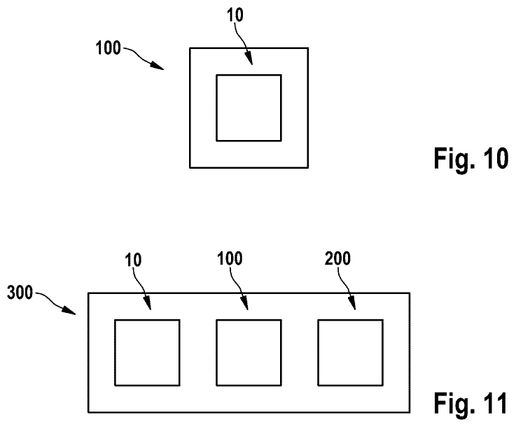

FIG. 10 shows a cleaning system 100 comprising a wiper system 10 as described above and below.

FIG. 11 shows a vehicle 300 according to one embodiment. The vehicle 300 preferably includes a wiper system 10 as described above and below. Further preferably, the vehicle 300 comprises a cleaning system 100 for cleaning a LiDAR sensor 200. Further preferably, the vehicle 300 comprises a LiDAR sensor 200.

1. A wiper system (10) for a LiDAR sensor (200), comprising:
a wiper lip (12) comprising an elastic material,
wherein the wiper lip (12) has a longitudinal extension direction (14),
wherein the wiper system comprises two bars (16),
wherein the two bars (16) are adapted to engage in two recesses (18) and the wiper lip (12) along the longitudinal extension direction (14),
wherein the wiper system (10) comprises a limiting unit (20) configured to be pushed onto the wiper lip (12) along the longitudinal extension direction (14) to secure the two bars (16) to the wiper lip (12),
wherein the wiper system (10) further comprises a connecting unit (22) configured to form a frictional-locking and/or positive-locking connection with the two bars (16),
wherein the connecting unit (22) is configured to arrange the wiper system (10) on a cleaning system (100) for the LiDAR sensor (200).

2. The wiper system (10) according to claim 1, wherein the two bars (16) comprise two tapers (24), wherein the connecting unit (22) is configured to suppress slippage between the connecting unit (22) and the wiper lip (12) along the longitudinal extension direction (14) through engagement of the connecting unit (22) with the tapers (24).

3. The wiper system (10) according to claim 1, wherein the connecting unit (22) comprises a U-shaped section (26), wherein the U-shaped section (26) and the two bars (16) are configured to provide the positive-locking and/or frictional-locking connection.

4. The wiper system (10) according to claim 3, wherein the connecting unit (22) comprises a phase (28) abutting the U-shaped portion (26) to assist in forming the frictional-locking and/or positive-locking connection.

5. The wiper system (10) according to claim 2, wherein the connecting unit (22) comprises a U-shaped section (26), wherein a length (30) of the two tapers (24) and a length (32) of the U-shaped section (26) are configured to define a degree of deflection of the wiper lip (12) to the connecting unit (22) when the wiper lip (12) is moved over the LiDAR sensor (200).

6. The wiper system (10) according to claim 1, wherein the two bars (16) each comprise a first hook element (34), wherein the limiting unit (20) comprises two second hook elements (36), wherein the two bars (16) form a snap connection between the two bars (16) and the limiting unit (20) by the first hook elements (34) and the second hook elements (36).

7. The wiper system (10) according to claim 6, wherein the limiting unit (20) has a U-shaped profile (38), wherein the U-shaped profile (38) is configured to guide at least one bar (16) to form the snap connection.

8. The wiper system (10) according to claim 1, wherein the limiting unit (20) comprises two pins (40) configured to engage in the two recesses (18) to form a frictional connection between the wiper lip (12) and the limiting unit (20).

9. The wiper system (10) according to claim 1, wherein the connecting unit (22) comprises two cut-outs (42), wherein a clip (44) is arranged in the two cut-outs (42), wherein the clip (44) is configured to form a frictional-locking and/or a positive-locking connection with the cleaning system (100).

10. The wiper system (10) according to claim 9, wherein the clip (44) has an opening width (46) that is larger than a diameter of a fastening location of the clip (44).

11. The wiper system (10) according to claim 9, wherein the clip (44) has an opening angle (48) between 20° and 30°.

12. The wiper system (10) according to claim 9, wherein the clip (44) comprises two arms (50), wherein a peak width (52) of the arms (50) is less than a base width (54) of the arms (50).

13. The wiper system (10) according to claim 12, wherein the peak width (52) of the clip (44) and the base width (54) of the clip (44) are configured to create a resistance force for mounting the wiper system (10) between 3 and 20 N.

14. A cleaning system (100) for a LiDAR sensor (200) comprising a wiper system according to claim 1, wherein the cleaning system (100) is configured to move the wiper system (10) over a field of view (202) of the LiDAR sensor (200) in order to clean the field of view (202).

15. A vehicle (300) comprising a cleaning system (100) according to claim 14.

16. The wiper system (10) according to claim 10, wherein the clip (44) has an opening angle (48) between 20° and 30°.

17. A vehicle (300) comprising a wiper system (10) according to claim 1.
